(19) United States
(12) Patent Application Publication
(10) Pub. No.: US 2013/0019808 A1
(43) Pub. Date: Jan. 24, 2013

(54) Pet Food Container Holding Apparatus

(71) Applicant: Del Lathim, Pasco, WA (US)

(72) Inventor: Del Lathim, Pasco, WA (US)

(21) Appl. No.: 13/554,345

(22) Filed: Jul. 20, 2012

Related U.S. Application Data
(60) Provisional application No. 61/510,853, filed on Jul. 22, 2011.

(51) Int. Cl. A01K 5/00

(52) U.S. Cl. 119/51.01

(57) ABSTRACT

The patent relates to pet food container holders. In one example the pet food container holder includes a sidewall that extends from a base to a top. The sidewall approximates a portion of a cone or a portion of a pyramid and defines a generally vertical passageway that extends from the base to the top. In this example the top includes a receiver that is configured to receive a single serving pet food container from a user. The receiver is further configured to retain the single serving pet food container. The top further includes a rim and an angled surface extending from the rim to the receiver. The angled surface is configured to direct pet food that is dropped by the pet back into the single serving pet food container.

### PRIORITY

This patent application is a non-provisional utility application that claims priority from a provisional application having Ser. No. 61/510,853 filed on Jul. 22, 2011, which is hereby incorporated by reference in its entirety.

### SUMMARY

The described implementations relate to pet food container holders. In one implementation the pet food container holder includes a sidewall that extends from a base to a top. The sidewall approximates a portion of a cone or a portion of a pyramid and defines a generally vertical passageway that extends from the base to the top. In this implementation the top includes a receiver that is configured to receive a single serving pet food container from a user. The receiver is further configured to retain the single serving pet food container. The top further includes a rim and an angled surface extending from the rim to the receiver. The angled surface is configured to direct pet food that is dropped by the pet back into the single serving pet food container.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1 and 10 are perspective views of examples of single serving pet food container holding apparatuses in accordance with some of the present concepts.

FIGS. 2-9 and 11-16 are sectional views of examples of single serving pet food container holding apparatuses in accordance with some of the present concepts.

### DETAILED DESCRIPTION

### Overview

The present description relates to a single serving pet food container holding apparatus (hereinafter, “SSPFC holder”). Consumers are increasingly purchasing “single serving” containers of pet food, such as cat food or dog food. Consumers like that the single serving pet food containers (hereinafter, “SSPF containers”) provide freshly opened pet food at each feeding. However, these SSPF containers tend to be relatively light and tend to be prone to spilling. The present implementations offer SSPFC holders which can receive and retain the containers until removed by a pet/owner/user. The SSPFC holders can reduce or eliminate spilled food and the undesired necessity of the owner cleaning up the spilled food.

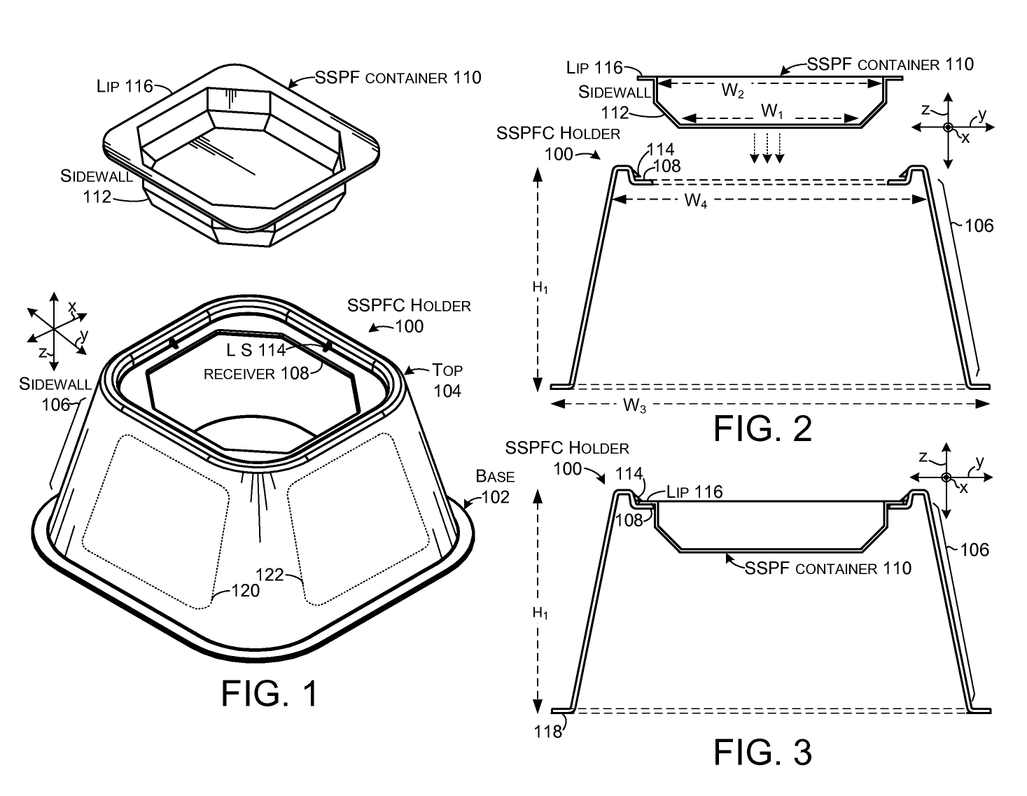

FIGS. 1-3 collectively show an example of a SSPFC holder 100. The SSPFC holder 100 can include a base 102 and extends upwardly to a top 104. In this case, a sidewall 106 connects the base 102 and the top 104. The top 104 can include a receiving portion or receiver 108 configured to receive a SSPF container 110. Note that the SSPF container can have a relatively narrow base (as represented by width W₁) compared to the width of the top (as represented by W₂). This configuration in combination with angled or curved sidewalls 112 can allow the pet to access most or all of the pet food, thereby reducing or eliminating ‘unobtainable’ food. However, this configuration also makes the SSPF container prone to spillage. In contrast, the SSPFC holder 100 can have a spill resistant configuration in that the base (as represented by width W₃) is as wide or wider than the top (as represented by width W₄) and a height H₁ can be less that the base width W₃, in some implementations.

In order to further reduce spillage, in some implementations, the SSPFC holder 100 can function to releasably retain the SSPF container 110 until a user (e.g., pet owner) removes the SSPF container (illustrated relative to FIG. 7). Toward this end, the SSPFC holder 100 can include a container retainment mechanism. In this particular implementation, the container retainment mechanism is manifest as a locking structure 114 that works cooperatively with the receiver 108 to lock a lip 116 of the SSPF container 110 into place. Further, when pets eat from the SSPF container, the pet may exert relatively large lateral forces (in the x and/or y directions). The SSPFC holder may include a slip resistant bottom surface 118 so that the pet does not push the holder across the floor (or other surface) while eating.

SSPFC holder 100 can also create an ergonomic eating experience for the pet. For instance, when the pet eats out of a SSPF container that is placed directly on the floor, the pet's throat can be bent to an extent to cause constriction and/or choking. In contrast, SSPFC holder 100 serves to elevate SSPF container 110 in the vertical (z) direction above the floor. In such a case, the pet can eat at a level such that the pet's throat is more horizontal and less subject to constriction and choking.

In some configurations, the SSPFC holder's sidewall 106 can be generally continuous. Such a configuration is represented in FIGS. 1-3. In an alternative configuration, the sidewall can be discontinuous. For instance, the sidewall 106 can be skeletonized to reduce material use during manufacture. Dotted lines 120 and 122 illustrate one such skeletonized configuration in that the area inside the lines can be thought of as a “hole” in the sidewall 106. In some configurations the base 102, sidewall 106, and top 104 can be of homogeneous construction, such as may be produced through a molding process. However, in other implementations, the sidewall 106 can be any structure that can function to connect the base and the top and may be made from a different material than the base and/or the top.

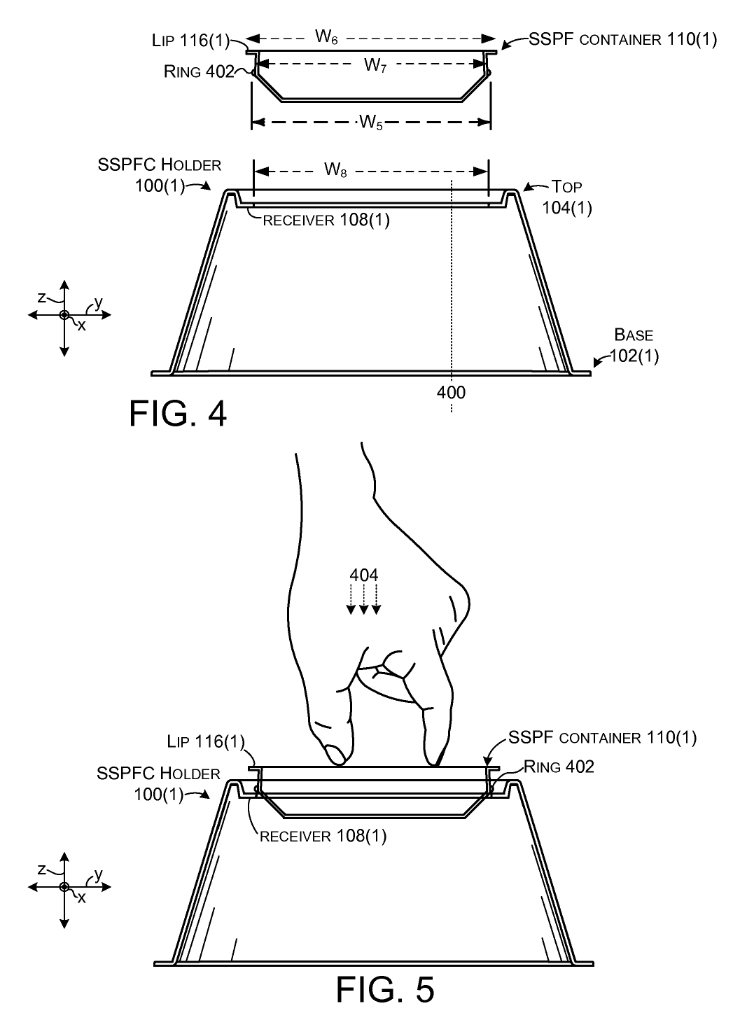

FIGS. 4-7 show another example SSPFC holder 100(1). This example maintains several of the elements introduced above relative to FIGS. 1-3, which are not re-introduced here for sake of brevity. The suffix “(1)” is utilized relative to FIGS. 4-7 to distinguish these elements from similar elements in the examples of FIGS. 1-3. Also, note that SSPFC holder 100(1) can define a generally vertical passageway 400 that extends through openings in the base 102(1) and the top 104(1).

The SSPFC holder 100(1) is configured to releasably retain SSPF container 110(1). In this case, SSPF container 110(1) includes a horizontal ring 402. The SSPF container is relatively wide at the ring (as indicated by width W₅) and at the lip 116(1) (as indicated by width W₆). In contrast, the SSPF container 110(1) is relatively narrower between the lip and the ring (as indicated by width W₇ (outside diameter). The SSPFC holder's receiver 108(1) can define an opening that has a width W₈ (inside diameter) that is approximately equal to width W₇ of the SSPF container, but is slightly greater than width W₅ defined by the ring 402. Thus, as illustrated in FIG. 5, a user can press downward (downward force 404) on the SSPF container to “snap” the ring 402 through the receiver 108(1). Downward movement of the SSPF container 110(1) can be stopped by the lid 116(1).

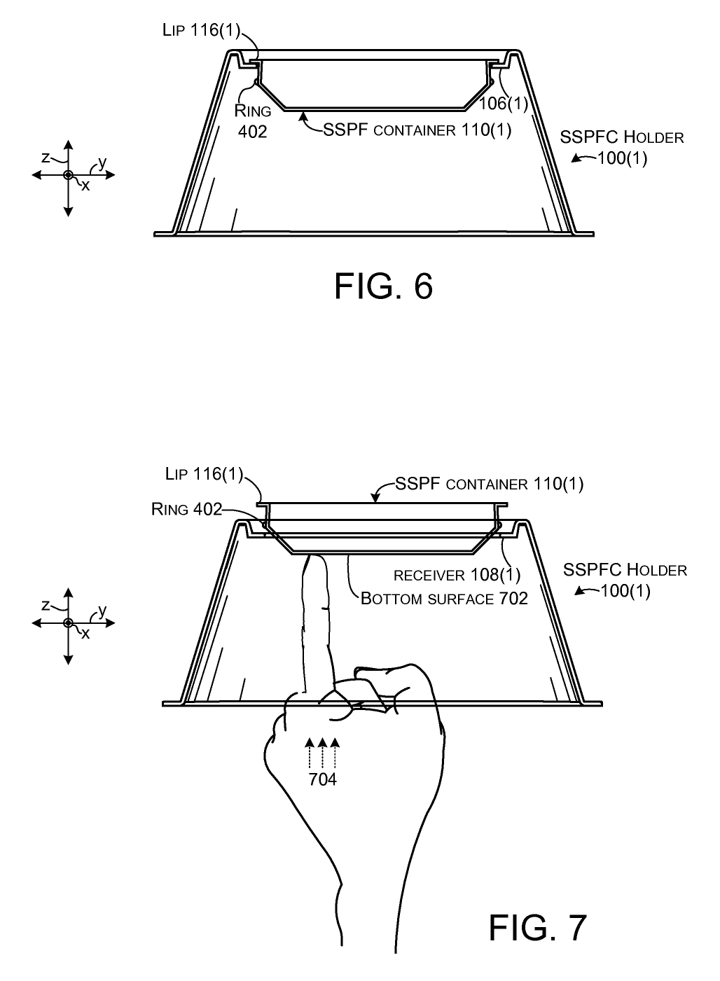

As illustrated in FIG. 6, in this configuration, the SSPF container 110(1) is retained by the SSPFC holder 100(1). The SSPFC's shape is tip resistant and thus tipping and/or spilling of the retained SSPF container is reduced or prevented. After the pet consumes the food in SSPF container 110(1), the user can grasp the SSPFC holder and push upwardly on a bottom surface 702 of the SSPF container (illustrated as upward force 704 in FIG. 7) to overcome the retention and remove the SSPF container from the SSPFC holder. Recall that SSPFC holder 100(1) defines generally vertical passageway 400 (FIG. 4) and that the user can insert his/her hand upward into the passageway from the base to apply the upward force 704 to overcome the retention mechanism and remove the SSPF container 110(1) from the SSPFC holder 100(1). Note also that in the optional skeletonized sidewall configuration discussed above relative to FIG. 1, the user could reach through a “hole” in the sidewall and then push upwardly on the bottom of the SSPF container 110(1).

To summarize, in the implementation of FIGS. 4-7 the receiver 108(1) functions as the container retainment mechanism so that the SSPF container 110(1) is retained in the SSPFC holder 100(1) until released by a user/pet owner.

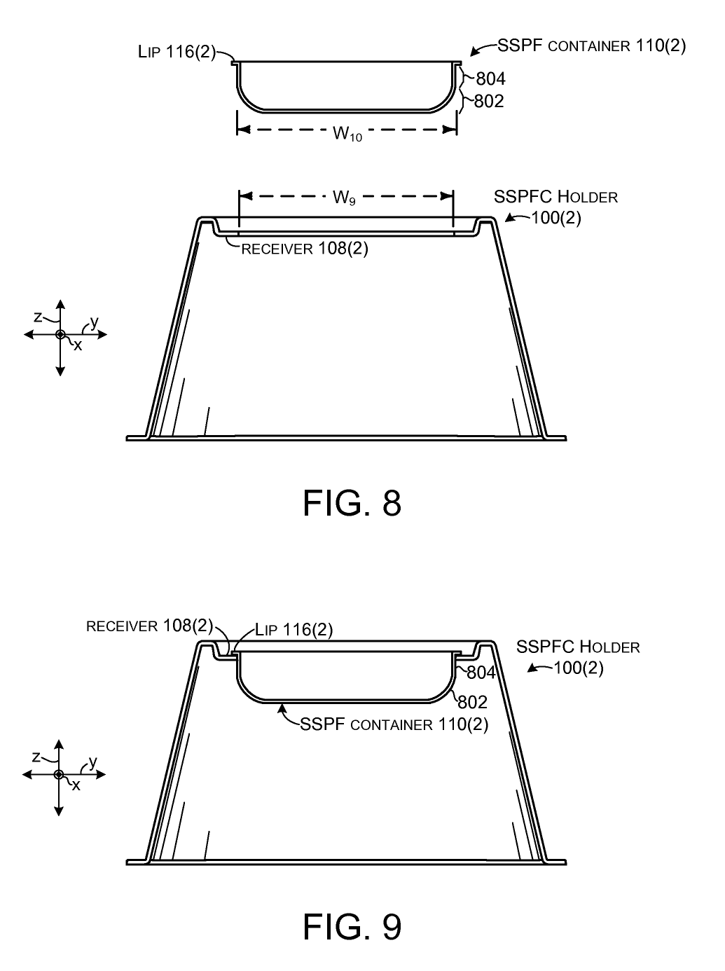

FIGS. 8-9 show another example SSPFC holder 100(2). In this case, the SSPF container 110(2) has a lower rounded sidewall portion 802 and an upper generally vertical sidewall portion 804. The receiver 108(2) defines an opening that generally corresponds to the shape of the SSPF container but which has a slightly smaller opening W₉ than a width W₁₀ defined by the upper generally vertical sidewall portion 804. The rounded configuration of the lower sidewalls 802 provides self-alignment as the pet owner/user pushes the SSPF container 110(2) into the receiver's opening. The owner/user will experience some resistance as the upper generally vertical sidewall portion 804 begins to contact the receiver 108(2). The owner/user can force the SSPF container 110(2) downward into the SSPFC holder until the lip 116(2) contacts the receiver 108(2). In this case, the receiver functions to releasably retain the SSPF container until the owner/user removes the SSPF container in a manner similar to that illustrated relative to FIG. 7.

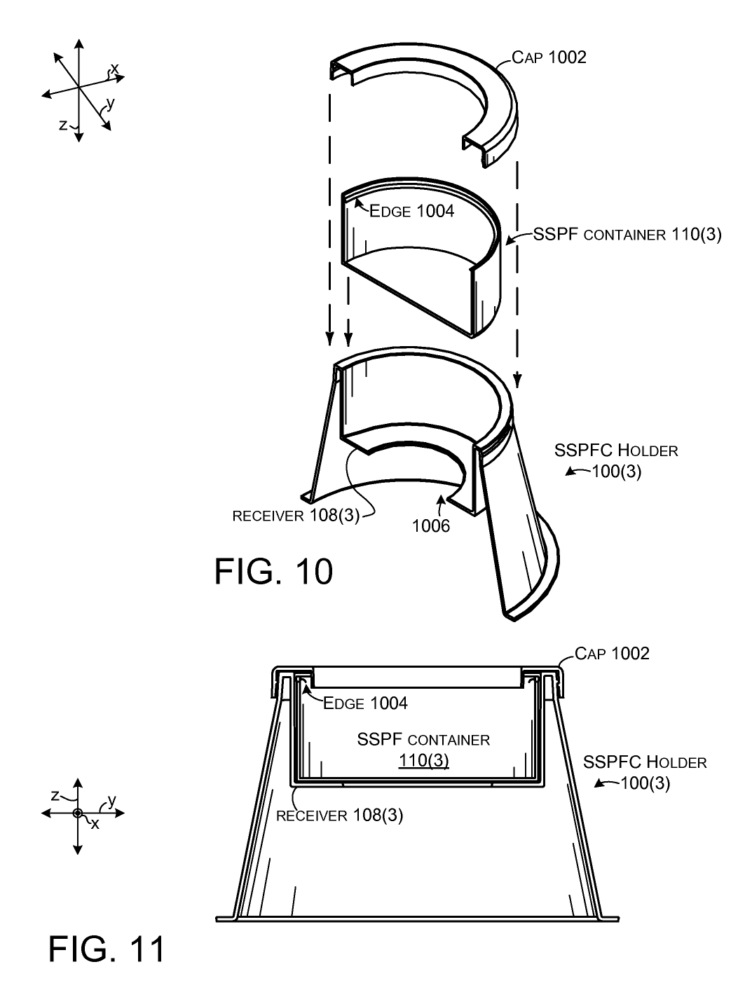

FIGS. 10-11 show another example SSPFC holder 100(3). In this example, the SSPFC holder includes a cap 1002. The cap and the receiver 108(3) operate cooperatively as a retainment mechanism as will be described below.

In this case, the SSPF container 110(3) is a traditional metal “tuna fish” shaped can. While not shown, in some cases, SSPF container 110(3), when sealed, includes a lid with a ring. The user can grab the ring and pull back on the ring to remove the lid and open the SSPF container. Removing the ring can leave a sharp exposed edge 1004 that can cut the pet's mouth when the animal tries to eat food from the SSPF container. However, this danger is eliminated by the configuration of SSPF container 110(3). The user places the opened SSPF container 110(3) into the SSPFC holder 100(3) until downward movement is stopped by receiver 108(3). Alternatively, the user can place the unopened SSPF container in the SSPFC holder 100(3) and then open the container. In either case, the user can now secure cap 1002 to the SSPFC holder. The cap can be configured to screw onto the SSPFC holder, “snap” in place, or utilize another securing mechanism. Once in place, the cap and the receiver function cooperatively to retain the SSPF container. Further, in this case, the cap 1002 overlaps the sharp edge 1004 and protects the pet from injury. The user can remove the SSPF container by first removing the cap. The bottom of the receiver may be partially open as indicated at 1006 to allow the user to push the SSPF container up from the bottom for removal from the SSPFC holder 100(3).

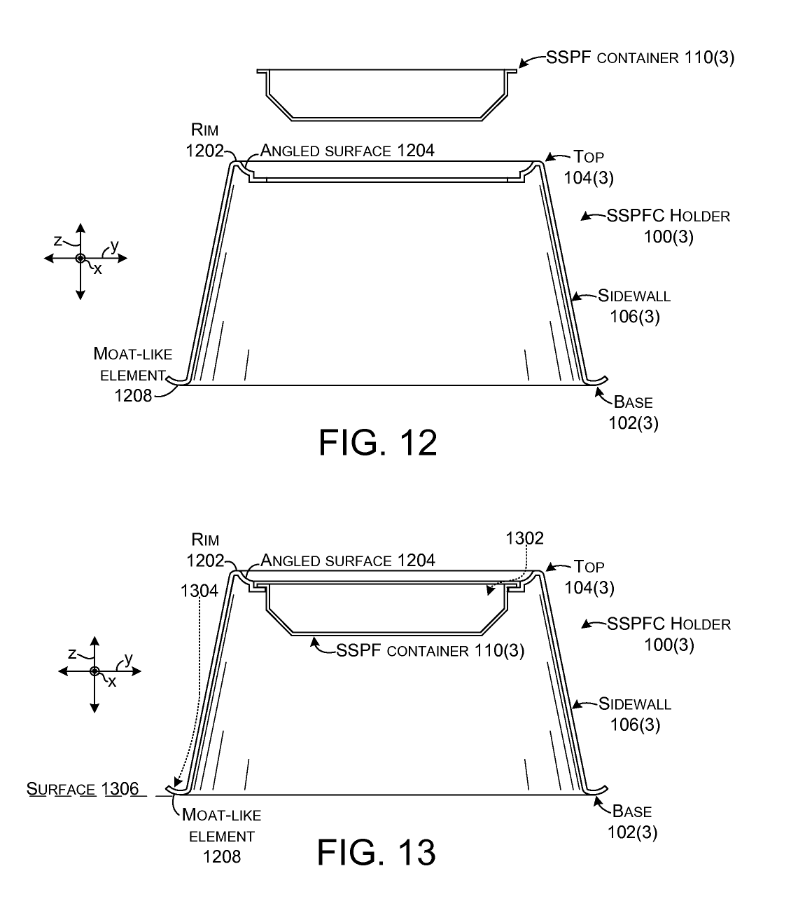

FIGS. 12-13 collectively show another example SSPFC holder 100(3) and associated SSPF container 110(3).

SSPFC holder 100(3) includes sidewall 106(3) that extends from base 102(3) to top 104(3). In this case, the top 104(3) includes receiver 108(3) that includes a rim 1202 and an angled surface 1204 extending from the rim 1202 to the receiver 108(3). In the present implementation, the base 102(3) includes a moat-like element 1208.

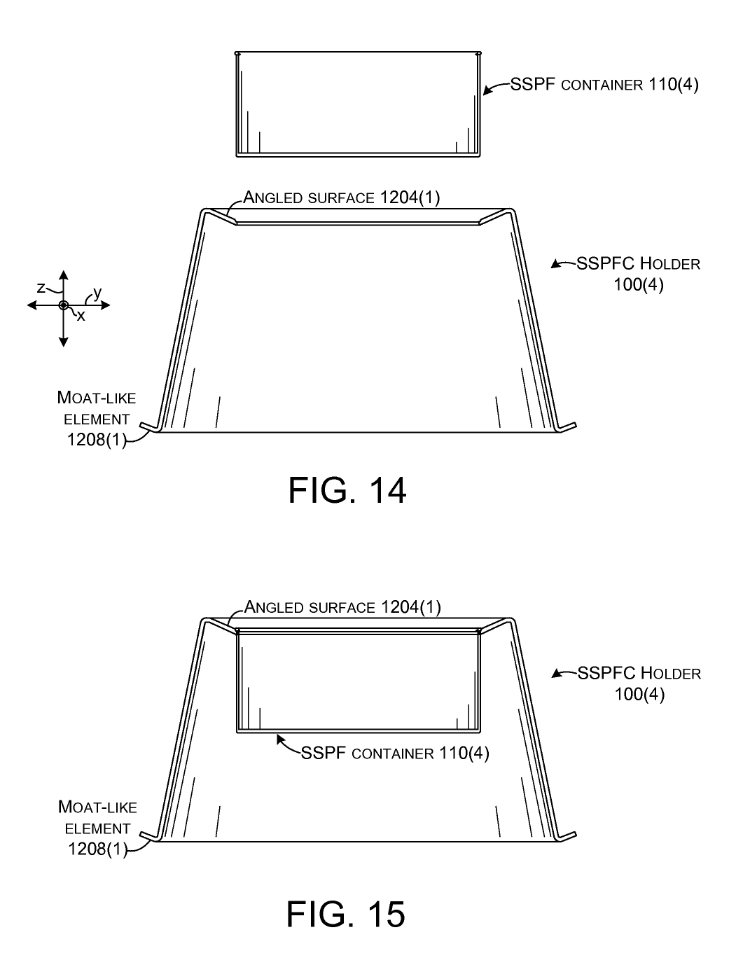

The angled surface 1204 is configured to direct pet food that is dropped by the pet back into the SSPF container 110(3) as indicated by arrow 1302. Stated another way, the angled surface 1204 can be configured to direct pet food that is dropped by the pet so that the pet food reenters the SSPF container. In the present implementation, as shown in the view of FIGS. 12-13 (e.g., when viewed along a vertical plane (e.g., the yz-reference plane) that passes through the rim, the receiver and the sidewall) the angled surface is curved. (FIGS. 14-15 show an alternative configuration).

The moat-like element 1208 can be configured to catch materials that slide down the sidewall 106(3) and to prevent the materials from contaminating a surface upon which the base is positioned. For instance, as indicated by arrow 1304, the moat-like element can contain these materials that would otherwise tend to end up on a surface 1306 upon which the base 102(3) is resting. In one such example, these materials can include pet food that is dropped by the pet while eating. In another instance, the materials can include oils or other materials applied to the sidewall to block pests, such as ants from climbing the SSPFC holder 100(3) to get to the pet food in the SSPF container 110(3). Alternatively or additionally, the moat-like element 1208 can allow the pet to grasp the SSPFC holder 100(3) with their front paws while eating. This configuration can keep the SSPFC holder 100(3) in a position desired by the pet. This position tends to be close to the pet and as such, the moat-like element can further reduce pet food spillage that is normally occurs as the SSPF container 110(3) slide away from the pet while eating.

FIGS. 14-15 collectively show another example SSPFC holder 100(4) and associated SSPF container 110(4). This implementation is similar in many respects to the implementation described above relative to FIGS. 12-13. However, note that in this case, angled surface 1204(1) and moat-like element 1208(1) are linear rather than curved when viewed in cross-section.

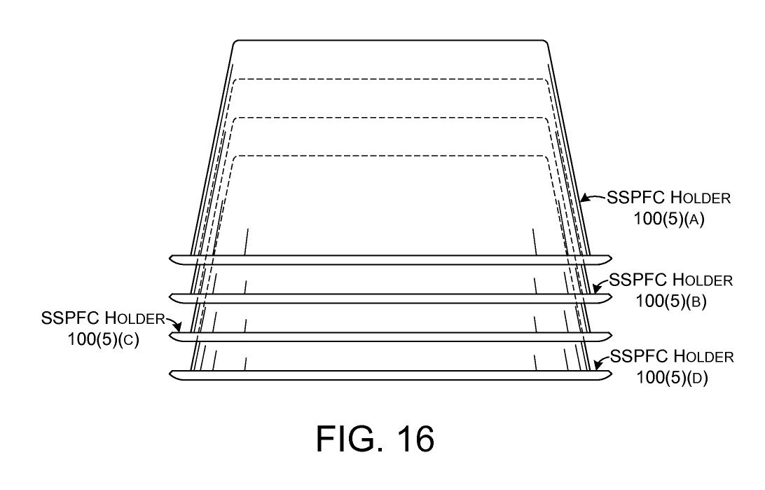

FIG. 16 shows an example of the stackable nature of at least some of the present implementations. In this case, four instances of SSPFC holder 100(5)(A), 100(5)(B), 100(5)(C), and 100(5)(D) are shown stacked, such as for shipping.

Note that while several different SSPF container shapes are illustrated and described, multiple additional variations exist or may be developed. While not all these variations can be illustrated, the present concepts can be applied to produce a SSPFC holder that can reduce spillage and/or otherwise create a more satisfied pet owner/user.

From one perspective, SSPFC holders 100-100(3) can be thought of as a tip-resistant apparatus for releasably retaining a SSPF container. Further, in some implementations, the SSPFC holder can be characterized as approximating a portion of a pyramid (FIGS. 1-3), a cone (FIGS. 10-11), or other structure. Such a shape can provide tip resistance while the pet eats from the retained SSPF container. Such a shape can also lend itself to space saving stacking of the SSPFC holders when stacked upon one another, such as for shipping. Viewed from one perspective, SSPFC holders can be thought of as being nestably stackable to save shipping resources.

SSPFC holders 100-100(3), and/or other implementations can be constructed of any suitable material(s) such as a polymer, plastic, metal, and/or composite. Any traditional fabrication technique can be utilized to form the SSPFC holders. For instance, some SSPFC holders can be formed by injection molding of polymers and others can be formed from stamped metal. The SSPFC holders can be of homogeneous construction or can be constructed from multiple materials.

In summary, the present implementations relate to single serving pet food container holders that can receive and retain single serving pet food containers until a pet owner/user decides to remove the container. Further, the single serving pet food container holders can be tip resistant so that the pet food is not spilled while retained.

### CONCLUSION

Although specific examples of single serving pet food container holders are described in language specific to structural features, it is to be understood that the subject matter defined in the appended claims is not intended to be limited to the specific features described. Rather, the specific features are disclosed as exemplary forms of implementing the claimed statutory classes of subject matter.

1. A single serving pet food container holder, comprising:
a sidewall that extends from a base to a top and approximates a portion of a cone or a portion of a pyramid and defines a generally vertical passageway that extends from the base to the top; and,
the top includes a receiver that is configured to receive a single serving pet food container from a user and wherein the receiver is further configured to retain the single serving pet food container and wherein the top further includes a rim and an angled surface extending from the rim to the receiver, the angled surface configured to direct pet food that is dropped by the pet back into the single serving pet food container.

2. The single serving pet food container holder of claim 1, wherein the angled surface is curved when viewed along a vertical plane that passes through the rim, the receiver and the sidewall.

3. The single serving pet food container holder of claim 1, wherein the base includes a moat-like element that is configured to catch materials that slide down the sidewall and is configured to prevent the materials from contaminating a surface upon which the base is positioned.

4. A single serving pet food container holder, comprising:
a sidewall that extends from a base to a top and approximates a portion of a cone or a portion of a pyramid and defines a generally vertical passageway that extends from the base to the top; and,
the top includes a receiver that is configured to receive a single serving pet food container from a user and wherein the receiver is further configured to retain the single serving pet food container while a pet consumes food contained therein and to release the single serving pet food container when the user reaches through the generally vertical passageway and applies an upward force to a bottom surface of the single serving pet food container.

5. The single serving pet food container holder of claim 4, wherein the sidewall is skeletonized or wherein the sidewall is continuous.

6. The single serving pet food container holder of claim 4, wherein the top further includes a rim and an angled surface extending from the rim to the receiver, the angled surface configured to direct pet food that is dropped by the pet to reenter the single serving pet food container.

7. The single serving pet food container holder of claim 4, wherein the base further includes a moat-like element that is configured to catch materials that slide down the sidewall and that is configured to prevent the materials from contaminating a surface upon which the base is positioned.

8. A single serving pet food container holder, comprising:
a tip-resistant base connected to and supporting a top that includes a receiver, the receiver configured to receive a single serving pet food container, the receiver further including a retainment mechanism configured to releasably retain the single serving pet food container until an upward force is applied to the single serving pet food container.

9. The single serving pet food container holder of claim 8, wherein the retainment mechanism comprises a locking structure, or wherein the retainment mechanism comprises the receiver, or wherein the retainment mechanism comprises a cap that operates cooperatively with the receiver.

10. The single serving pet food container holder of claim 8, wherein the single serving pet food container holder is nestably stackable with other single serving pet food container holders.
